(19) United States
(12) Patent Application Publication
(10) Pub. No.: US 2018/0305244 A1
(43) Pub. Date: Oct. 25, 2018

(54) TRANSPARENT SUBSTRATES COMPRISING NANOCOMPOSITE FILMS AND METHODS FOR REDUCING SOLARIZATION

(71) Applicant: CORNING INCORPORATED, CORNING, NY (US)

(72) Inventors: Nicholas Francis BORRELLI, Elmira, NY (US); Wageesha SENARATNE, Horseheads, NY (US)

(73) Assignee: CORNING INCORPORATED, Corning, NY (US)

(21) Appl. No.: 15/769,616

(22) PCT Filed: Oct. 19, 2016
(86) PCT No.: PCT/US2016/057581

§ 371 Date: Apr. 19, 2018

Related U.S. Application Data
(60) Provisional application No. 62/243,908, filed on Oct. 20, 2015.

(51) Int. Cl. C03C 17/00; C03C 17/25; C03C 17/30

(52) U.S. Cl. CPC C03C 17/007; C03C 17/25; C03C 17/30; C03C 2218/32; C03C 2217/29; C03C 2217/78; C03C 2218/116; C03C 2217/216

(57) ABSTRACT

Disclosed herein are methods for reducing the solarization of a glass substrate, the methods comprising depositing a nanocomposite layer on at least a portion of a surface of the glass substrate, wherein the nanocomposite layer comprises a mixture of metal oxide nanoparticles and at least one silicon-containing component, wherein the metal oxide nanoparticles comprise at least one metal oxide having a band gap ranging from about 3 eV to about 4 eV. Also disclosed herein are glass substrates comprising a surface and a nanocomposite coating on at least a portion of the surface, wherein the nanocomposite coating comprises a mixture of metal oxide nanoparticles and at least one silicon-containing component.

### CROSS-REFERENCE TO RELATED APPLICATIONS

This application claims the benefit of priority under 35 U.S.C. § 119 of U.S. Provisional Application Ser. No. 62/243,908 filed on Oct. 20, 2015, the content of which is relied upon and incorporated herein by reference in its entirety.

### FIELD OF THE DISCLOSURE

The disclosure relates generally to transparent substrates comprising nanocomposite films, and more particularly to glass substrates comprising metal oxide nanocomposite films and methods for reducing solarization of glass substrates.

### BACKGROUND

Glass substrates may be used in numerous applications, both as internal and external components. For instance, in electronic applications (e.g., for televisions, computers, handheld devices, and the like), glass substrates may serve both as an exterior glass surface, as well as one or more interior components (e.g., wiring substrates, light guides, and lenses, to name a few). Glass substrates are also useful for numerous automotive applications, and may further be used in a variety of architectural structures and interior furnishings, including appliances. Often such glass components are readily visible to a user and, thus, it may be desirable to prevent unwanted discoloration of the glass over time. Alternatively, the glass may not be visible to the user, but it may be desirable or necessary to prevent the discoloration of such interior components to preserve their functionality over time.

As such, the reduction or prevention of glass solarization has recently gained importance in several industries. The term “solarization” is used to describe the colorization of glasses due to prolonged exposure to light, e.g., ultraviolet (UV) wavelengths. Recent studies have shown that the UV portion of the spectrum (>4 eV; <400 nm) may provide the relevant excitation resulting in solarization of glasses. Such solarization can have a negative impact in devices or other glass components regularly exposed to UV light, for instance, when UV light is used to cure coatings, such as polymer coatings, on a glass; when lasers operating at UV wavelengths are used to score, cut, or seal glass substrates; when electronic components emit UV light; when UV light is used to clean glass; or when UV wavelengths are discharged during other glass treatment methods, such as plasma treatment or deposition processes, to name a few.

The solarization phenomenon may be analyzed in connection with the “band gap” of the glass. The band gap refers to an energy range in a solid where no electron states can exist. Stated otherwise, the band gap is the difference in energy (in electron volts, eV) between the top of the valence band (electron-filled) to the bottom of the conduction band (electron-empty). By way of comparison, the band gap for conducting and semi-conducting materials is relatively small, whereas the band gap for insulating materials, such as glasses, is often relatively large. As such, light having a relatively high energy (e.g., >4 eV; <300 nm) may exceed the glass band gap and thus provide ionizing radiation capable of producing free electrons in the glass.

The band gap is generally understood as a “forbidden” gap that is nominally empty of electron states. However, other localized states may exist in this gap, such as multivalent impurities encountered during the glass manufacturing process or defect centers produced by light exposure. These impurities and/or defects may have energy levels falling in the forbidden band gap, which can trap any electrons produced by the ionizing radiation. As a result, such electrons may produce undesirable color centers in the glass substrate.

Current methods for reducing solarization in glasses can comprise including one or more components in the glass composition itself that are capable of absorbing ionizing radiation. For instance, one or more oxides (e.g., ZnO, TiO₂, SrO₂, SnO, Sb₂O₃, and Nb₂O₅) may be included in the batch materials for the glass composition. The metal ions in these oxides can form glass network modifiers which can absorb ionizing radiation such that it does not produce electrons in the glass, thereby suppressing glass coloration. However, such absorbers may have an upper concentration limit at which absorption in the visible portion of the spectrum occurs, which can limit the application of such glasses for optical purposes. As such, practical considerations may result in a maximum concentration for the absorber(s), which may not be sufficient to completely combat the solarization effect.

As an alternative to doping the glass composition itself with absorbing oxides, a film coating may also be applied to the glass substrate. Such coatings may filter out wavelengths producing ionizing radiation. For instance, the coating can comprise one or more components having a band gap ranging from about 3 eV to about 4 eV (e.g., SnO₂, TiO₂, ZnO, doped ZnO, etc.). However, such coatings may also have various limitations, for instance, in terms of coating thickness. Whereas thicker (e.g., >200 nm) coatings may be desirable for maximum absorption of ionizing radiation, such thicknesses may also result in interference and the production of significant perceived coloration. Accordingly, it would be advantageous to provide glass substrates that are resistant to solarization while also exhibiting minimal coloration and/or absorption in the visible portion of the spectrum. It would also be advantageous to provide a coating or film which can be applied to any glass substrate to reduce the solarization phenomenon, without altering the chemical composition of the glass substrate itself.

### SUMMARY

The disclosure relates, in various embodiments, to methods for reducing the solarization of a glass substrate, the methods comprising depositing a nanocomposite layer on at least a portion of a surface of the glass substrate, wherein the nanocomposite layer comprises a mixture of metal oxide nanoparticles and at least one silicon-containing component, wherein the metal oxide nanoparticles comprise at least one metal oxide having a band gap ranging from about 3 eV to about 4 eV. Also disclosed herein are glass substrates comprising a surface and a nanocomposite layer on at least a portion of the surface, wherein the nanocomposite layer comprises a mixture of metal oxide nanoparticles and at least one silicon-containing component, and wherein the metal oxide nanoparticles comprise at least one metal oxide having a band gap ranging from about 3 eV to about 4 eV. Further disclosed herein are glass substrates comprising a surface and a nanocomposite layer on at least a portion of the surface, wherein the nanocomposite layer comprises a mixture of metal oxide nanoparticles and at least one silicon-containing component, and wherein a weight ratio of the at least one silicon-containing component to the metal oxide nanoparticles ranges from about 0.01:1 to about 1.5:1.

According to various embodiments, the at least one metal oxide may be chosen from ZnO, TiO₂, SnO₂, and combinations thereof. In additional embodiments, the metal oxide nanoparticles may be doped with at least one additional metal, e.g., up to about 5% by weight. The doped or undoped metal oxide may, in certain embodiments, have an excitonic absorption at room temperature, for instance, having an exciton binding energy ranging from about 1 meV to about 60 meV. The average particle size of the nanoparticles may, in various embodiments, range from about 1 nm to about 200 nm. In further embodiments, the nanocomposite layer may comprise from about 40% to about 98% by weight of the metal oxide nanoparticles and from about 2% to about 60% by weight of the at least one silicon-containing component. According to yet further embodiments a weight ratio of the at least one silicon-containing component to the metal oxide nanoparticles may range from about 0.01:1 to about 1.5:1. In still further embodiments, an average thickness of the nanocomposite layer may range from about 50 nm to about 1 μm.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings.

FIG. 1 depicts an exemplary glass substrate coated with a nanocomposite layer according to various embodiments of the disclosure;

FIGS. 2A-B are absorption spectra for a glass substrate sputter coated with a ZnO film before and after exposure to UV laser radiation;

FIG. 3A is an absorption spectrum for a glass substrate spin coated with a ZnO nanocomposite layer before and after exposure to UV laser radiation;

FIG. 3B is an absorption spectrum for an uncoated glass substrate before and after exposure to UV laser radiation;

FIGS. 4A-B are absorption spectra for a glass substrate before and after exposure to UV laser radiation, where the substrate was spin coated with a nanocomposite layer comprising ZnO and silicon polymer and heated to 300° C. before UV laser exposure;

FIGS. 5A-B are absorption spectra for a glass substrate before and after exposure to UV laser radiation, where the substrate was spin coated with a nanocomposite layer comprising ZnO and silicon polymer and heated to 420° C. before UV laser exposure;

FIG. 6 depicts coated and uncoated glass substrates after exposure to UV laser radiation;

FIG. 7A depicts the transmission spectra for an uncoated glass substrate before and after exposure to a UVO radiation source;

FIG. 7B depicts the transmission spectra for a glass substrate spin coated with a ZnO nanocomposite layer before and after exposure to a UVO radiation source; and

FIG. 8 depicts color point data for the coated and uncoated glass substrates of FIGS. 7A-B before and after exposure to a UVO radiation source.

### DETAILED DESCRIPTION

### Methods

Disclosed herein are methods for reducing the solarization of a glass substrate, the methods comprising depositing a nanocomposite layer on at least a portion of a surface of the glass substrate, wherein the nanocomposite layer comprises a mixture of metal oxide nanoparticles and at least one silicon-containing component, wherein the metal oxide particles comprise at least one metal oxide having a band gap ranging from about 3 eV to about 4 eV.

As used herein, the term “nanocomposite” is intended to refer to a multi-phase solid material comprising two or more components, at least one of which comprises nanoparticles having at least one dimension less than about 200 nm. For example, a nanocomposite can comprise a mixture of one or more types of nanoparticles which may, for instance, have an average particle size or diameter of less than 200 nm, and which may be combined with another component, such as at least one silicon-containing component. Of course, it is to be understood that the nanocomposite is not limited to those comprising spherical nanoparticles and any particle shape is envisioned as falling within the scope of the disclosure. Additionally, it is to be understood that the nanocomposite may not be in solid form during application (e.g., solutions, suspensions, etc.), but can solidify during or after application to form the nanocomposite film. The terms “film,” “layer,” and “coating” are used interchangeably herein to refer to a composite structure formed on a glass surface by the nanoparticles.

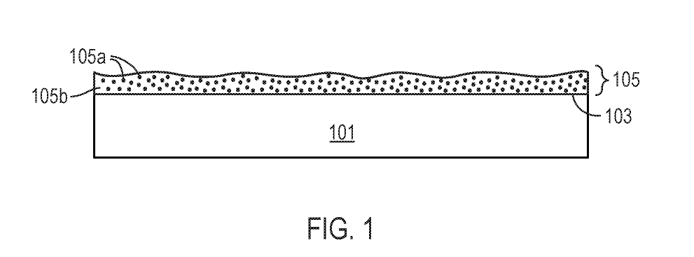

Methods and substrates disclosed herein will generally be discussed with reference to FIG. 1, which illustrates an exemplary glass substrate comprising a nanocomposite layer according to non-limiting embodiments of the disclosure. The following general description is intended to provide an overview of the claimed methods and substrates. Various aspects will be more specifically discussed throughout the disclosure with reference to the non-limiting embodiments, these embodiments being interchangeable with one another within the context of the disclosure.

According to various embodiments, the nanocomposite film can be deposited on at least a portion of a surface of a glass substrate. Referring to FIG. 1, the glass substrate 101 can comprise at least one surface 103 upon which the nanocomposite layer 105 can be formed. The nanocomposite layer can comprise, in certain embodiments, a combination of one or more metal oxide nanoparticles 105a and at least one silicon-containing component 105b.

While FIG. 1 depicts metal oxide nanoparticles 105a dispersed in a silicon-containing component 105b, it is to be understood that two or more metal oxide nanoparticle types can be used, for example, the silicon-containing component may be mixed with two or more types of metal oxide nanoparticles, and so on. Additionally, while the metal oxide nanoparticles 105a are depicted as dispersed in the silicon-containing component 105b, the nanocomposite layer 105 can comprise a mixture or combination of these components in any form. For example, the nanocomposite layer 105 can comprise nanoparticles 105a dispersed in a matrix of silicon-containing component 105b (e.g., a silicon-containing polymer), or a mixture with a silicon-containing component 105b (e.g., silica nanoparticles), or any combination thereof. Furthermore, according to additional embodiments, the nanocomposite layer 105 can further comprise trapped air bubbles (not shown). Still further, while FIG. 1 depicts the nanocomposite layer 105 as covering the entire surface 103, it is to be understood that only a portion of the surface may be coated, e.g., a central portion, peripheral portions, one or more edges, as well as strips, spots, squares, and other patterns.

The nanocomposite layer 105 can be deposited or otherwise applied to the glass surface 103 using any suitable method known in the art. For example, a solution or suspension of nanoparticles can be applied to the glass surface by spin coating, spray coating, dip coating, brush coating, slot coating, roller coating, inkjet printing, screen printing, or dispense printing, to name a few. In the case of solutions or suspensions, one or more aqueous or organic solvents may be combined with the nanoparticles, such as water, deionized water, alcohols, volatile hydrocarbons, and combinations thereof. For example, solvents may include acetone, methanol, ethanol, propanol, methoxy propanol, ethylene glycol, propylene glycol methyl acetate, dimethyl sulfoxide (DMSO), N,N-dimethylformamide (DMF), N-methyl-2-pyrrolidone (NMP), pyridine, tetrahydrofuran (THF), dichloromethane, xylene, hexane, and combinations thereof.

In some embodiments, the nanocomposite layer 105 can have an average thickness ranging from about 50 nm to about 1 μm, such as from about 100 nm to about 750 nm, from about 150 nm to about 500 nm, from about 200 nm to about 400 nm, or from about 250 nm to about 300 nm, including all ranges and subranges therebetween. In other embodiments, the nanocomposite layer can have a thickness that varies along the surface, for example, with thicker coatings in a first region, thinner coatings in a second region, and/or no coating in a third region or, alternatively, a thickness gradient may be created along one or more dimensions of the surface. The thickness and/or placement of the nanocomposite coating can be determined, for example, based on the amount of UV exposure expected for a particular region.

According to various embodiments, the nanocomposite layer 105 can comprise at least one type of metal oxide nanoparticles 105a combined with at least one silicon-containing component 105b. In some embodiments, the nanocomposite layer 105 can comprise two or more types of nanoparticles, such as three or more, four or more, five or more, six or more, and so on. The nanoparticles 105a may have at least one dimension of about 200 nm or less, such as less than about 180 nm, less than about 160 nm, less than about 140 nm, less than about 120 nm, less than about 100 nm, less than about 80 nm, less than about 70 nm, less than about 60 nm, less than about 50 nm, less than about 40 nm, less than about 30 nm, less than about 20 nm, less than about 10 nm, or less than about 5 nm, e.g., ranging from about 1 nm to about 200 nm. The nanoparticles may have any regular or irregular shape, such as spheroid, ovoid, platelet, and other shapes. The at least one dimension may thus correspond to a diameter, length, width, height, or any other suitable dimension.

The nanoparticles 105a can comprise or consist essentially of at least one metal oxide. Exemplary metal oxides include, for example, ZnO, TiO₂ (e.g., rutile or anatase), SnO₂, and combinations thereof. In some embodiments, the metal oxide may be chosen from those having band gaps ranging from about 3 eV to about 4 eV (e.g., 3, 3.1, 3.2, 3.3, 3.4, 3.5, 3.6, 3.7, 3.8, 3.9, or 4 eV). In additional embodiments, the metal oxide may exhibit excitonic absorption at room temperature. For instance, the metal oxide may have an exciton binding energy at room temperature as high as 60 meV, such as ranging from about 1 meV to about 50 meV, from about 2 meV to about 40 meV, from about 3 meV to about 30 meV, from about 4 meV to about 25 meV, from about 5 meV to about 20 meV, or from about 10 meV to about 15 meV, including all ranges and subranges therebetween. According to non-limiting embodiments, the nanocomposite layer can comprise at least about 40% by weight of metal oxide nanoparticles, such as from about 50% to about 98%, from about 60% to about 95%, from about 70% to about 90%, or from about 75% to about 80%, including all ranges and subranges therebetween.

In various embodiments, the metal oxide nanoparticles may be doped with at least one additional metal. For example, a dopant may be used to modify the band gap and/or excitonic absorption of the metal oxide if desired. Suitable dopants may include, by way of non-limiting example, metals that can form metal oxides having a relatively high band gap. According to some embodiments, the additional metal oxide may have a band gap of greater than about 4 eV, such as ranging from about 4 eV to about 10 eV, from about 5 eV to about 8 eV, or from about 6 eV to about 7 eV, including all ranges and subranges therebetween. In additional embodiments, the additional metal oxide may have a band gap of less than about 3 eV, such as ranging from about 1 eV to about 2 eV, including all ranges and subranges therebetween. Non-limiting exemplary dopants may include, for instance, Mg, Al, alkali metals, and combinations thereof. In various embodiments, the metal oxide nanoparticles can be doped with up to about 5% by weight of the at least one additional metal, for example, ranging from about 0.1% to about 5%, from about 0.2% to about 4%, from about 0.3% to about 3%, from about 0.4% to about 2%, from about 0.5% to about 1%, from about 0.6% to about 0.9%, or from about 0.7% to about 0.8%, including all ranges and subranges therebetween.

The nanocomposite layer 105 can also include at least one silicon-containing component 105b. For example, the silicon-containing component may be chosen from silicon-containing polymers such as siloxane resins, methyl or phenyl siloxanes, methyl or phenyl silsesquioxanes, and polyoctahedrylsilsesquioxanes (POSS), sol-gel mixtures, silicates, silica, silica nanoparticles, and mixtures thereof, to name a few. In certain embodiments, the at least one silicon-containing component can be a polymer which, after heating, may or may not be at least partially converted to silica particles or nanoparticles. According to non-limiting embodiments, the nanocomposite layer can comprise at least about 2% by weight of the at least one silicon-containing component, such as from about 2% to about 60%, from about 5% to about 50%, from about 10% to about 40%, or from about 20% to about 30%, including all ranges and subranges therebetween. In various embodiments, a weight ratio of the at least one silicon-containing component to the metal oxide nanoparticles in the nanocomposite layer can range from about 0.01:1 to about 1.5:1, such as from about 0.02:1 to about 1:1, or from about 0.05:1 to about 0.5:1, including all ranges and subranges therebetween.

In some embodiments, deposition of the nanocomposite layer can comprise applying a liquid solution or suspension of the nanoparticles to at least a portion of a surface of the glass substrate. For example, a silicon-containing component can be added to a solution or suspension of nanoparticles, or vice versa, or two or more solutions or suspensions can be combined to form a mixture. In such embodiments, the methods disclosed herein may further include a drying or heating step, e.g., for the removal of the solvent(s). Drying may take place at ambient pressure and temperature, or elevated temperatures and/or reduced pressures may be employed. For example, the glass substrate may be heated and/or placed in a vacuum to at least partially remove the solvent. In some instances, the solvent is completely or substantially removed from the nanocomposite layer. Exemplary heat treatment temperatures can range, for example, from about 50° C. to about 600° C., from about 100° C. to about 500° C., from about 150° C. to about 450° C., from about 200° C. to about 400° C., or from about 250° C. to about 350° C., including all ranges and subranges therebetween.

In certain embodiments, metal oxide nanoparticles can be produced or otherwise provided, e.g., purchased. Exemplary methods for producing nanoparticles can include various plasma and/or vaporization techniques such as chemical vapor deposition (CVD), plasma-enhanced CVD (PECVD), or sputtering. For instance, in the case of CVD or PECVD, one or more precursors may be vaporized and oxidized to produce metal oxide nanoparticles. For example, in the case of zinc oxide (ZnO), the precursor can include any liquid, gas, or vapor component comprising Zn, such as dimethyl zinc, diethyl zinc, and zinc acetyl-acetonate, to name a few. Similar precursors can be chosen to produce TiO₂ and SnO₂ nanoparticles. It is within the ability of one skilled in the art to choose the appropriate type and amount of precursor for a given application. Oxidizing agents can include any liquid, gas, or vapor component comprising oxygen, such as air, O₂ gas, H₂O, H₂O₂, and the like.

Sputtering techniques can include reactive and non-reactive sputtering, such as DC and/or RF magnetron sputtering and ion beam sputtering. In the case of non-reactive sputtering, sputtering targets may comprise metal oxide and silica targets and sputtering may take place in an inert environment. Reactive sputtering, on the other hand, may employ pure metal targets (such as Zn, Ti, Sn, Mg, etc.) or metal-containing targets and sputtering may take place in an oxidizing environment. For example, ZnO nanoparticles may be formed by sputtering a ZnO target in an inert environment comprising argon or nitrogen gas, or by sputtering a Zn target in an oxidizing environment such as O₂ gas, which may optionally be mixed with an inert gas such as argon. Doped nanoparticles can be created, for example, by including an additional sputtering target, such as a metal oxide or metal target (e.g., MgO or Mg targets).

According to various embodiments, the methods disclosed herein can include additional optional steps that can be carried out before and/or after deposition of the nanocomposite film on the substrate. For instance, before deposition, the substrate can be optionally cleaned, e.g., using water and/or acidic or basic solutions. In some embodiments, the substrate can be cleaned using water, a solution of H₂SO₄ and/or H₂O₂, and/or a solution of NH₄OH and/or H₂O₂. The substrates can, for example, be rinsed with the solutions or washed for a period of time ranging from about 1 minute to about 10 minutes, such as from about 2 minutes to about 8 minutes, from about 3 minutes to about 6 minutes, or from about 4 minutes to about 5 minutes, including all ranges and subranges therebetween. Ultrasonic energy can be applied during the cleaning step in some embodiments. The cleaning step can be carried out at ambient or elevated temperatures, e.g., temperatures ranging from about 25° C. to about 150° C., such as from about 50° C. to about 125° C., from about 65° C. to about 100° C., or from about 75° C. to about 95° C., including all ranges and subranges therebetween. Other additional optional steps can include, for example, cutting, polishing, grinding, and/or edge-finishing of the substrate, to name a few.

### Substrates

Disclosed herein are glass substrates comprising a surface and a nanocomposite layer on at least a portion of the surface, wherein the nanocomposite layer comprises a mixture of metal oxide nanoparticles and at least one silicon-containing component, and wherein the metal oxide nanoparticles comprise at least one metal oxide having a band gap ranging from about 3 eV to about 4 eV. Also disclosed herein are glass substrates comprising a surface and a nanocomposite layer on at least a portion of the surface, wherein the nanocomposite layer comprises a mixture of metal oxide nanoparticles and at least one silicon-containing component, and wherein a weight ratio of the at least one silicon-containing component to the metal oxide nanoparticles in the nanocomposite layer ranges from about 0.01:1 to about 1.5:1.

Exemplary glass substrates can comprise, for example, any glass known in the art that is suitable for graphene deposition and/or display devices including, but not limited to, aluminosilicate, alkali-aluminosilicate, borosilicate, alkali-borosilicate, alum inoborosilicate, alkali-alum inoborosilicate, soda lime silicate, and other suitable glasses. In certain embodiments, the substrate may have a thickness of less than or equal to about 3 mm, for example, ranging from about 0.1 mm to about 2.5 mm, from about 0.3 mm to about 2 mm, from about 0.7 mm to about 1.5 mm, or from about 1 mm to about 1.2 mm, including all ranges and subranges therebetween. Non-limiting examples of commercially available glasses suitable for use as a light filter include, for instance, EAGLE XG®, Iris™, Lotus™, Willow®, Gorilla®, HPFS®, and ULE® glasses from Corning Incorporated. Suitable glasses are disclosed, for example, in U.S. Pat. Nos. 4,483,700, 5,674,790, and 7,666,511, which are incorporated herein by reference in their entireties, which are incorporated herein by reference in their entireties.

The glass substrate can, in various embodiments, be transparent or substantially transparent before and/or after coating with the nanocomposite layer. As used herein, the term “transparent” is intended to denote that the substrate, at a thickness of approximately 1 mm, has a transmission of greater than about 80% in the visible region of the spectrum (e.g., 400-700 nm). For instance, an exemplary glass substrate or coated glass substrate may have greater than about 85% transmittance in the visible light range, such as greater than about 90%, or greater than about 92% transmittance, including all ranges and subranges therebetween. A substantially transparent substrate may transmit greater than about 50% of wavelengths in the visible region. In certain embodiments, the glass substrate, before and/or after coating, may absorb wavelengths in the ultraviolet (UV) region (e.g., 100-400 nm). For instance, an exemplary glass substrate or coated glass substrate may have greater than about 50% absorption in the UV spectrum, such as greater than about 55%, greater than about 60%, greater than about 65%, greater than about 70%, greater than about 75%, greater than about 80%, greater than about 85%, greater than about 90%, greater than about 95%, or greater than about 99% absorption, including all ranges and subranges therebetween.

The substrate can comprise a glass sheet having a first surface and an opposing second surface. The surfaces may, in certain embodiments, be planar or substantially planar, e.g., substantially flat and/or level. The substrate can also, in some embodiments, be curved about at least one radius of curvature, e.g., a three-dimensional substrate, such as a convex or concave substrate. The first and second surfaces may, in various embodiments, be parallel or substantially parallel. The substrate may further comprise at least one edge, for instance, at least two edges, at least three edges, or at least four edges. By way of a non-limiting example, the substrate may comprise a rectangular or square sheet having four edges, although other shapes and configurations are envisioned and are intended to fall within the scope of the disclosure.

A “coated substrate” as used herein is intended to refer to a glass substrate comprising a nanocomposite layer on at least a portion of one surface. In some embodiments, at least a portion of the first surface and/or second opposing surface of the glass substrate may be coated with the nanocomposite layer. As noted above, one or more surfaces may be fully coated with the nanocomposite layer, or may be partially coated or patterned with the nanocomposite to produce any desired effect.

The nanocomposite layer may be applied to any glass substrate to serve as an absorber for UV radiation. The metal oxide nanoparticles may be chosen such that the resulting film has a band gap effective for UV absorption (e.g., about 3-4 eV). Moreover, the metal oxide nanoparticles may also exhibit excitonic absorption that may provide a sharp cut-off for the absorption, such that the nanocomposite layer absorbs in the UV region but not in the visible region of the spectrum. For example, the absorption cut-off may be around 400 nm or less, such as about 390 nm, about 380 nm, about 370 nm, about 360 nm, about 350 nm, about 340 nm, about 330 nm, about 320 nm, about 310 nm, or about 300 nm, e.g., ranging from about 300 nm to about 400 nm.

Without wishing to be bound by theory, it is believed that combining the metal oxide nanoparticles with at least one silicon-containing component may reduce the interference that might otherwise occur from a film comprising the metal oxide nanoparticles (e.g., ZnO, TiO₂, SnO₂) alone, particularly for thicker films (e.g., >200 nm). For example, the presence of silicon in the nanocomposite layer may reduce the effective index of the layer and/or result in an index fluctuation within the coating such that the interference effect of the overall layer is reduced. The reduced interference caused by the nanocomposite layer may result in coated glass substrates with less coloration. The presence of a silicon-containing component, such as a silicon-containing polymer, in the nanocomposite layer may furthermore improve the adhesion of the layer to the glass substrate. Such films can be applied to any glass substrate without the need to make changes to the glass composition itself. Moreover, the coatings can be applied using simple methods and/or inexpensive materials such that the coating does not or does not substantially negatively impact product cost and/or time. Of course the coated glass substrates may not have one or all of the above advantages but are still intended to fall within the scope of the disclosure.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a layer” includes examples having two or more such layers unless the context clearly indicates otherwise. Likewise, a “plurality” is intended to denote “more than one.” As such, a “plurality of layers” includes two or more such layers, such as three or more such layers, etc.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, such as within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### EXAMPLES

### Comparative Example 1

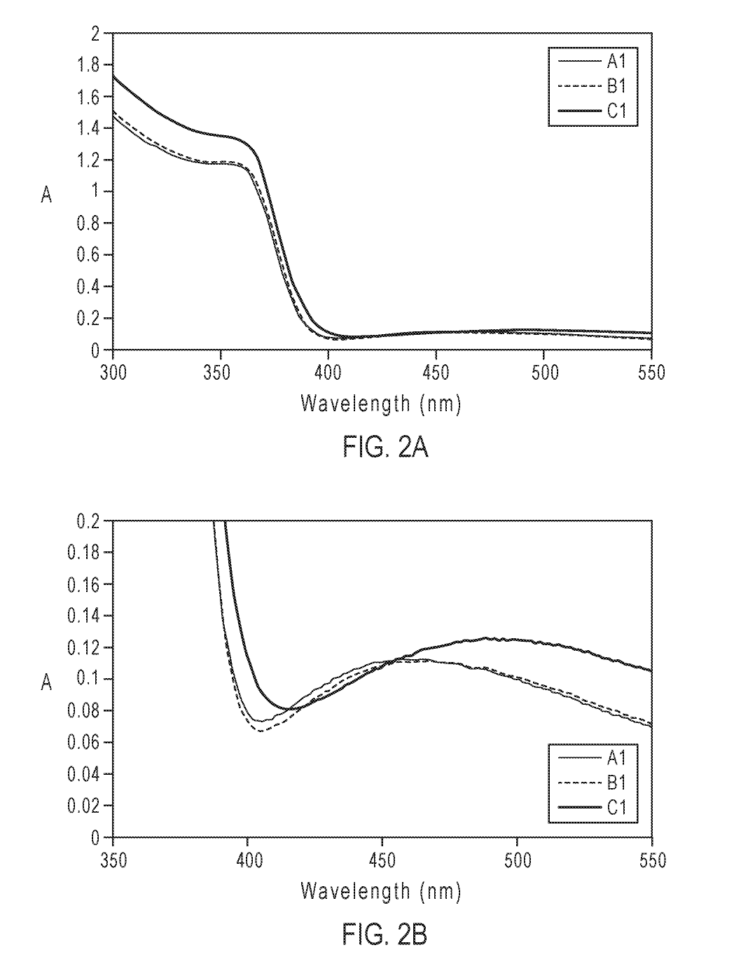

Glass substrates (Corning EAGLE XG®) were sputter coated to produce a ZnO film on one side (200 nm). The coated and uncoated surfaces of the glass substrates were then exposed to UV laser radiation (248 nm excimer laser, 200 mW/cm², 10 Hz, 10 minutes, 12 J/cm²). FIG. 2A illustrates the absorption spectra of the samples before laser exposure (A1) and after laser exposure (B1: coated side; C1: uncoated side). Noticeably, the sputtered ZnO film exhibited an exciton absorption sufficient to provide a sharp absorption cut-off around 360 nm. Referring to FIG. 2B, which is an enlarged portion of the spectra in FIG. 2A, it can be seen that the absorption spectra (at wavelengths <400 nm) A1 and B1 substantially overlap. By contrast, the absorption spectrum C1 was noticeably shifted as compared to spectra A1 and B1. An overlap between the absorption spectra A1 and B1 indicates that no induced absorption occurred in the coated substrate due to laser exposure. However, a slight color aspect produced by interference created by the ZnO film was visibly observed. Practically speaking, this slight coloration may make the coated substrate unsuitable for some applications.

### Example 2

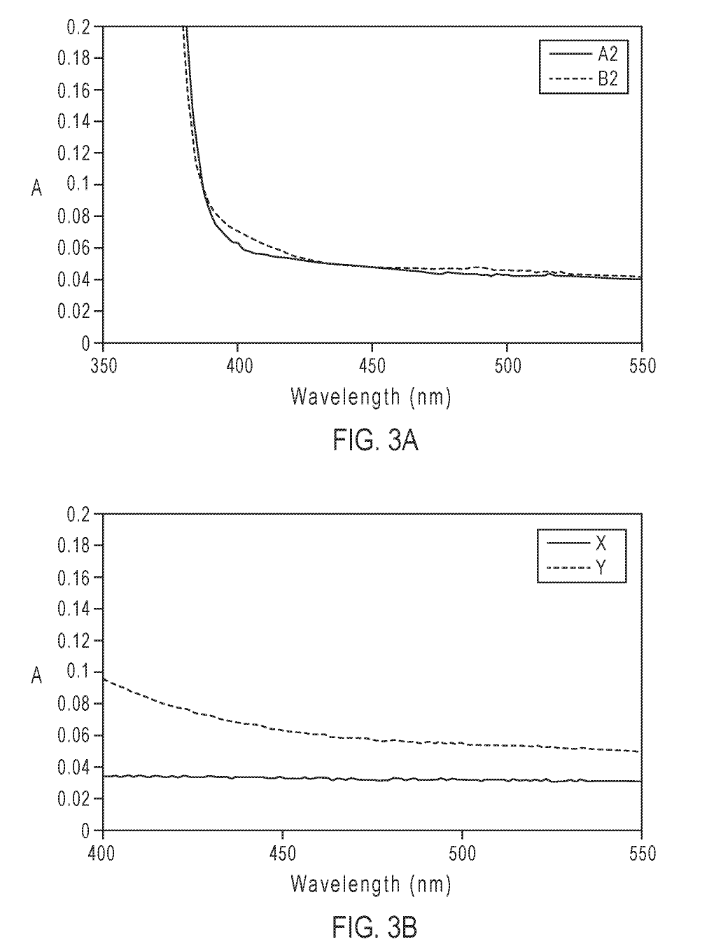

Glass substrates (Corning Iris™ WS-1) coated on one side with a ZnO-nanocomposite film (<500 nm) were prepared by spin coating the substrates with a solution of silicon-containing polymer and ZnO nanoparticles and heating the resulting film at 300° C. for 1 hour. The coated glass substrates were then exposed to UV laser radiation (248 nm excimer laser, 200 mW/cm², 10 Hz, 10 minutes, 12 J/cm²) and compared to uncoated (bare) glass substrates. FIG. 3A illustrates the absorption spectra of the coated samples before laser exposure (A2) and after laser exposure (B2: coated side). Much like the ZnO films of Example 1, the ZnO nanocomposite films exhibited an exciton absorption sufficient to provide a sharp absorption cut-off around 360 nm. The absorption spectra (at wavelengths <400 nm) A2 and B2 also substantially overlap, indicating that no induced absorption occurred in the coated substrate due to laser exposure. The difference in absorption between the two spectra A2 and B2 at 400 nm was 0.0009 a.u. and 0.004 a.u. at 500 nm. In contrast, it can be seen from FIG. 3B that the absorption spectra for the uncoated substrate before laser exposure (X) and after laser absorption (Y) do not overlap. Unlike the ZnO films of Example 1, interference in the nanocomposite coated substrates was suppressed and no coloration of the substrate was visibly observed.

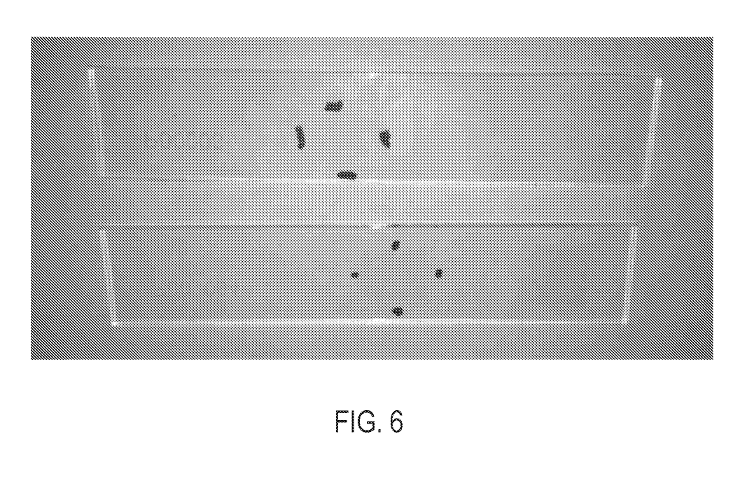

FIG. 6 is a photograph of the coated (top) and uncoated (bottom) Iris™ glass substrates after exposure to the laser. For the coated (top) substrate, the exposed region demarcated by the black dots did not show any significant signs of solarization. In contrast, the exposed region demarcated by the black dots in the uncoated (bottom) substrate exhibited significant coloration indicative of solarization. A second exposed area (not bracketed) with significant coloration can also be seen on the uncoated substrate.

### Example 3

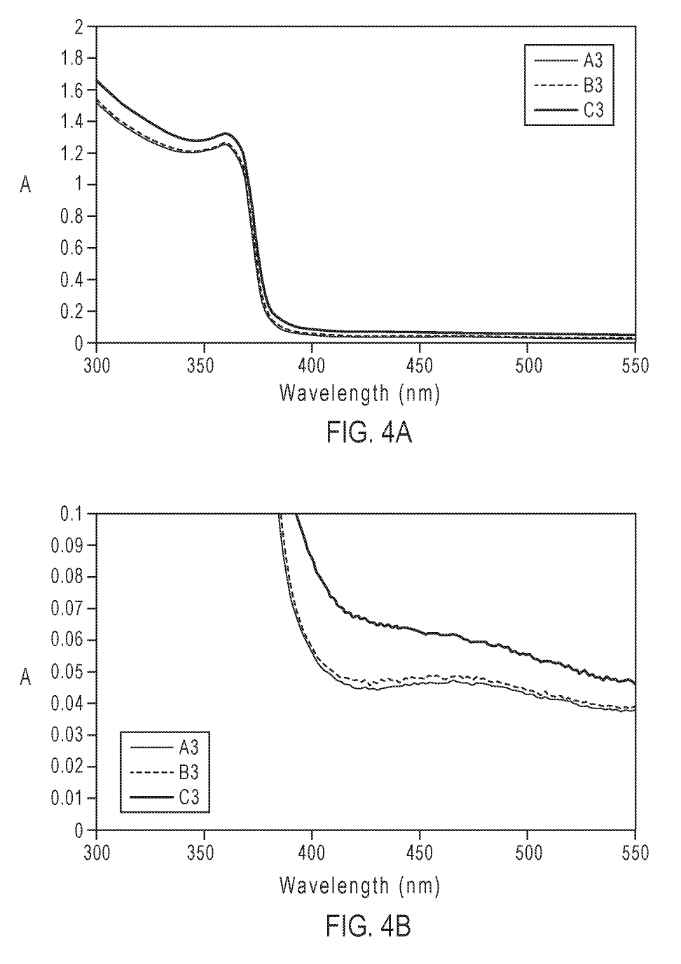

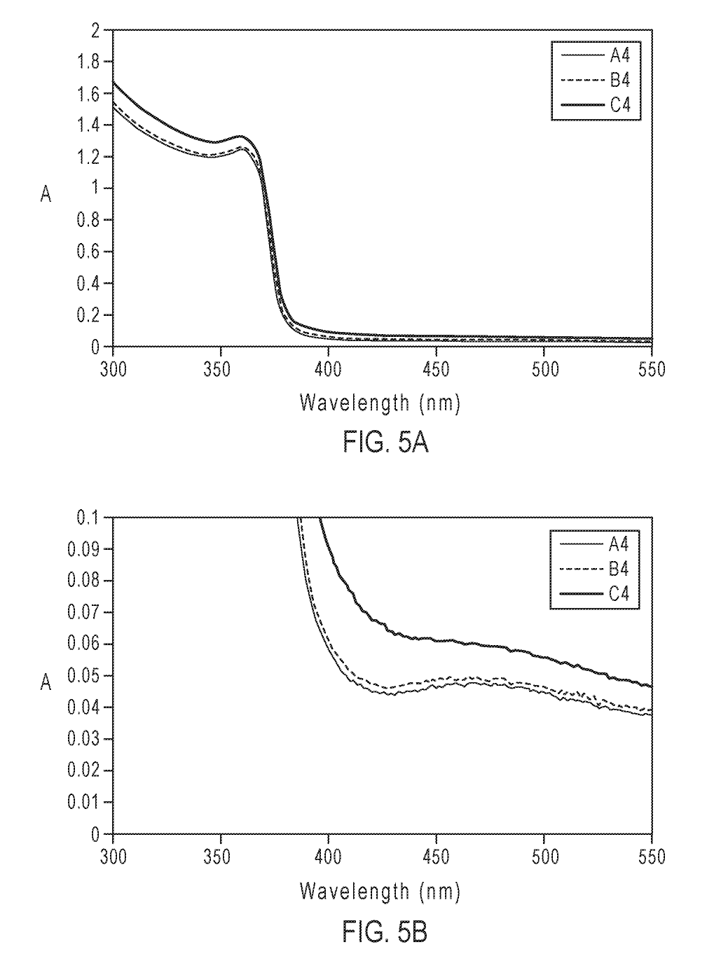

Glass substrates (Corning 4318 glass) coated on one side with a ZnO nanocomposite film (>500 nm) were prepared by spin coating the substrates with a solution of silicon-containing polymer and ZnO nanoparticles at 3000 rpm and heating the resulting film at 300° C. or 420° C. for 1 hour. The coated and uncoated surfaces of the glass substrates were then exposed to UV laser radiation (248 nm excimer laser, 200 mW/cm², 10 Hz, 10 minutes, 12 J/cm²). FIG. 4A illustrates the absorption spectra of the samples before laser exposure (A3) and after laser exposure (B3: coated side; C3: uncoated side) for samples heated 300° C., and FIG. 4B is an enlarged portion of the spectra in FIG. 4A. FIG. 5A illustrates the absorption spectra of the samples before laser exposure (A4) and after laser exposure (B4: coated side; C4: uncoated side) for samples heated at 420° C., and FIG. 5B is an enlarged portion of the spectra in FIG. 5A. Similar to the nanocomposite films produced in Example 2, induced absorption and interference were not observed in the coated substrates. A sharp cut-off in absorption around 360 nm was observed due to exciton absorption.

### Example 4

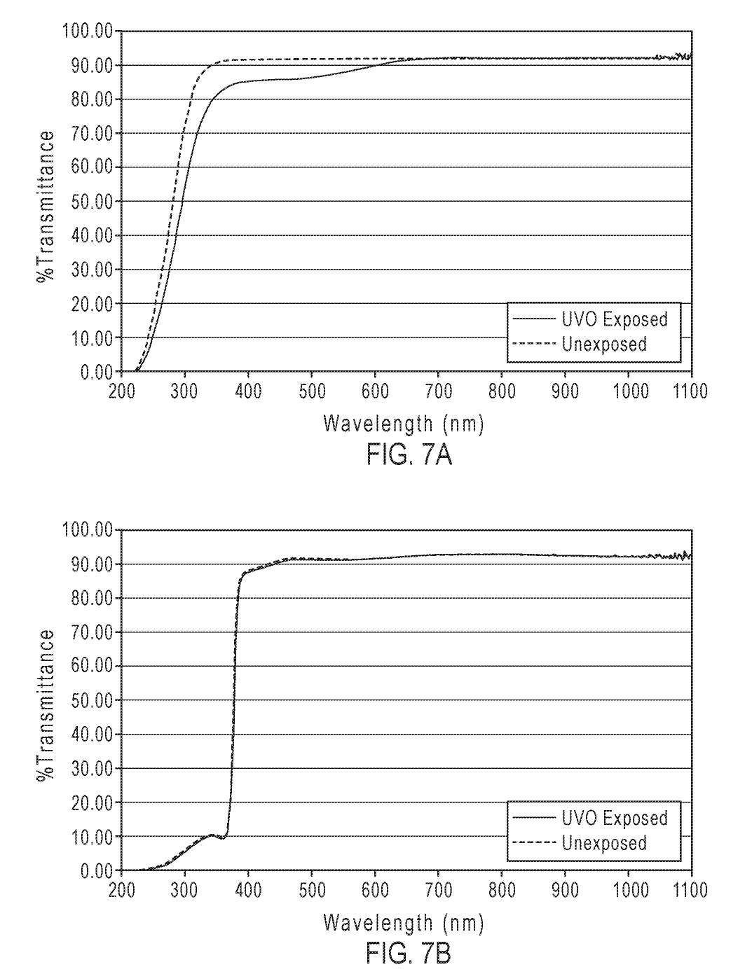

Glass substrates (Corning Gorilla® Glass 4, 600 nm) coated on one side with a ZnO nanocomposite film (>500 nm) were prepared by spin coating the substrates with a solution of silicon-containing polymer and ZnO nanoparticles and heat treating the resulting film. The coated glass substrate was then exposed to a UV/O₃ (UVO) radiation source for more than 15 minutes. FIG. 7A illustrates the transmission spectra for bare (uncoated glass) before and after UVO radiation exposure. FIG. 7B illustrates the transmission spectra of the coated sample before and after UVO radiation exposure. Similar to the nanocomposite films produced in Examples 2-3, induced absorption and interference were not observed in the coated substrates. A sharp cut-off in absorption around 360 nm was also observed due to exciton absorption. By contrast, the transmission spectrum of the bare glass after radiation exposure was noticeably shifted as compared to spectrum of the unexposed bare glass.

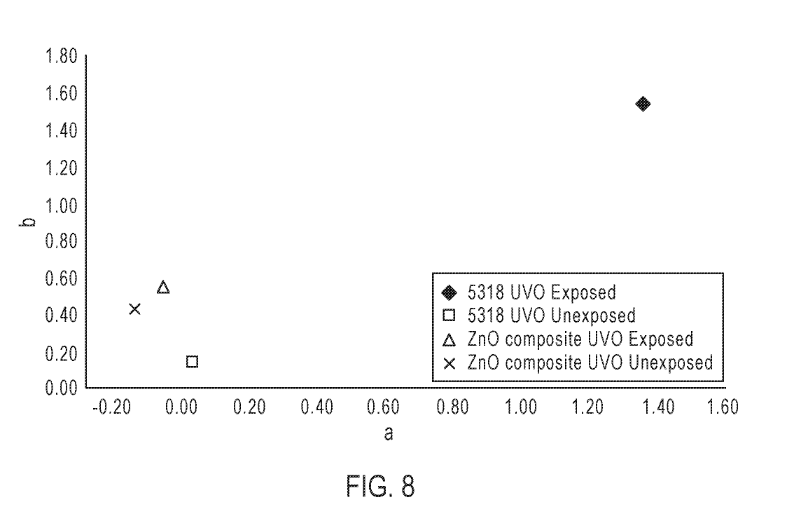

FIG. 8 shows color point data (CIE Standard Illuminant D65) for the exposed and unexposed bare and coated Gorilla® Glass 4 substrates of Example 4. As can be seen in the plot, whereas a large color difference was observed for the bare glass, a very small change in coloration is observed for the coated glass substrates. Without wishing to be bound by theory, it is believed that the reduced interference in the coated substrates of Examples 2-4 and, thus, reduced coloration of the substrate, may be due to the quasi-continuous structure of the film, and a reduced effective index may be due to the formation of a nanoparticle composite layer.

1. A glass substrate comprising a surface and a nanocomposite layer on at least a portion of the surface, wherein the nanocomposite layer comprises a mixture of metal oxide nanoparticles and at least one silicon-containing component, and wherein the metal oxide nanoparticles comprise at least one metal oxide having a band gap ranging from about 3 eV to about 4 eV.

2. The glass substrate of claim 1, wherein the at least one metal oxide is chosen from ZnO, TiO₂, SnO₂, and combinations thereof.

3. The glass substrate of claim 1, wherein the at least one metal oxide has an excitonic absorption at room temperature.

4. The glass substrate of claim 1, wherein the at least one metal oxide has an exciton binding energy ranging from about 1 meV to about 60 meV.

5. The glass substrate of claim 1, wherein the metal oxide nanoparticles are doped with at least one additional metal chosen from Mg, Al, alkali metals, and combinations thereof.

6. The glass substrate of claim 5, wherein the metal oxide nanoparticles comprise from about 0.1% to about 5% by weight of the at least one additional metal.

7. The glass substrate of claim 1, wherein the metal oxide nanoparticles have an average particle size ranging from about 1 nm to about 200 nm.

8. The glass substrate of claim 1, wherein a weight ratio of the at least one silicon-containing component to the metal oxide nanoparticles ranges from about 0.01:1 to about 1.5:1.

9. The glass substrate of claim 1, wherein the nanocomposite layer comprises from about 40% to about 98% by weight of metal oxide nanoparticles.

10. The glass substrate of claim 1, wherein the nanocomposite layer has an average thickness ranging from about 50 nm to about 1 μm.

11. The glass substrate of claim 1, wherein the glass substrate is substantially transparent.

12. The glass substrate of claim 1, wherein the glass substrate has an absorption cut-off between about 300 nm and about 400 nm.

13. A method for reducing the solarization of a glass substrate, the method comprising depositing a nanocomposite layer on at least a portion of a surface of the glass substrate, wherein the nanocomposite layer comprises a mixture of metal oxide nanoparticles and at least one silicon-containing component, and wherein the metal oxide nanoparticles comprise at least one metal oxide having a band gap ranging from about 3 eV to about 4 eV.

14. The method of claim 13, wherein depositing the nanocomposite layer comprises at least one of spin coating, spray coating, dip coating, slot coating, inkjet printing, screen printing, and dispense printing.

15. The method of claim 14, wherein the depositing nanocomposite layer further comprises heating the nanocomposite layer a temperature ranging from about 150° C. to about 450° C.

16. The method of claim 13, wherein the at least one metal oxide is chosen from ZnO, TiO₂, SnO₂, and combinations thereof.

17. The method of claim 13, wherein the metal oxide nanoparticles are doped with at least one additional metal chosen from Mg, Al, alkali metals, and combinations thereof.

18. The method of claim 13, wherein the metal oxide nanoparticles have an average particle size ranging from about 1 nm to about 200 nm.

19. The method of claim 13, wherein a weight ratio of the at least one silicon-containing component to the metal oxide nanoparticles ranges from about 0.01:1 to about 1.5:1.

20. The method of claim 13, wherein the nanocomposite layer has an average thickness ranging from about 50 nm to about 1 μm.

21. A glass substrate comprising a surface and a nanocomposite layer on at least a portion of the surface, the nanocomposite layer comprising a mixture of metal oxide nanoparticles and at least one silicon-containing component, wherein a weight ratio of the at least one silicon-containing component to the metal oxide nanoparticles ranges from about 0.01:1 to about 1.5:1.

22. The glass substrate of claim 21, wherein the metal oxide nanoparticles comprise at least one metal oxide chosen from ZnO, TiO₂, SnO₂, and combinations thereof.

23. The glass substrate of claim 21, wherein the metal oxide nanoparticles have an excitonic absorption at room temperature.

24. The glass substrate of claim 21, wherein the metal oxide nanoparticles are doped with at least one additional metal chosen from Mg, Al, alkali metals, and combinations thereof.

25. The glass substrate of claim 24, wherein the metal oxide nanoparticles comprise from about 0.1% to about 5% by weight of the at least one additional metal.

26. The glass substrate of claim 21, wherein the metal oxide nanoparticles have an average particle size ranging from about 1 nm to about 200 nm.

27. The glass substrate of claim 21, wherein the nanocomposite layer comprises from about 40% to about 98% by weight of metal oxide nanoparticles.

28. The glass substrate of claim 21, wherein the nanocomposite layer has an average thickness ranging from about 50 nm to about 1 μm.

29. The glass substrate of claim 21, wherein the glass substrate is substantially transparent.

30. The glass substrate of claim 21, wherein the substrate has an absorption cut-off between about 300 nm and about 400 nm.
